(19) United States
(12) Patent Application Publication
(10) Pub. No.: US 2003/0220813 A1
(43) Pub. Date: Nov. 27, 2003

(54) Electronic system and method coupling live event ticketing with sale of event recordings

(76) Inventor: Amy R. Gurvey, Upper Montclair, NJ (US)

Correspondence Address: GOTTLIEB RACKMAN & REISMAN PC, 270 MADISON AVENUE, 8TH FLOOR, NEW YORK, NY, 100160601

(21) Appl. No.: 10/442,468

(22) Filed: May 20, 2003

Related U.S. Application Data
(60) Provisional application No. 60/382,710, filed on May 22, 2002.
(60) Provisional application No. 60/382,949, filed on May 24, 2002.

(51) Int. Cl. G06F 17/60

(52) U.S. Cl. 705/1

(57) ABSTRACT

The present disclosure provides a method and system of electronically associating the sale of a “recording” from a live performance or event with the sale of a ticket to that event, such that the purchaser is able to automatically acquire the recording subsequent to his attendance at the event. Distribution of the recording (including but not limited to patrons, outside purchasers and ancillary purchasers and/or licensees) by all means now known or hereafter devised, including, but not limited to, by live broadcast, over-the-air television, radio, network, cable, pay-per-view, film, Internet or other transmission system as may hereafter be devised) is contemplated including, but not limited to, by hand or automated, expedited delivery to attendees at the venue by the time the event is over.

### RELATED APPLICATIONS

This application claims the benefit of U.S. Provisional Application No. 60/392.710 filed May 22, 2002 and U.S. Provisional Application No. 60/382,949 filed May 24, 2002.

### TECHNICAL FIELD

The present invention relates to integrated systems and methods for associating the simultaneous sale, accounting and optional tracking of a recording from a live entertainment event to the sale of a ticket to the event. The present invention also presents methods of selling edited and other derivative recordings including “best of” compilations, director's cuts, and narration tracks and associating these derivative releases with ticketing and the systems herein disclosed. To the extent that distribution and retrieval of a recording will occur at the venue immediately upon completion of the event, standard industry methods of authentication may be optionally incorporated at the time of retrieval.

### BACKGROUND OF THE INVENTION

Historically, a significant number of entertainment events have been either broadcast live or recorded for delayed broadcast, audio and/or audiovisual release to the global market. These recordings were first made on film, then tape, and now are recorded by digital technology. In some cases, the recordings were purposely made for subsequent marketing to a mass audience comprised mostly of people who did not attend the original event. These were and continue to be very expensive productions designed with high quality values to appeal to that market.

But in a vast majority of cases, as exemplified by smaller productions such as recitals, concerts by newer unsigned bands, “lower” league/non-pro sport competitions and speeches/educational seminars, the recordings are made for reference or promotional purposes only, using simple equipment of modest quality and they are rarely heard or seen again. Such live performances and events usually end up as “lost content” and to date, no entity has successfully capitalized on them. It is not unusual that a solo great talent or an ensemble of great talents may appear in a unique performance, as in a benefit concert, gala, limited tour or opening or perform in a smaller market for a particular function or celebration, and the production will be lost forever. Many view the failure to offer these releases as depriving the public of an artist's complete repertoire and/or interfering with a contemporary composer's right to publicity. The May 15, 1999 Carnegie Hall recital of the New Goldberg Variations by cellist YoYo Ma with a single piano accompanist, is such an example. Rarely are performances at Carnegie Hall, Tanglewood, the Hollywood Bowl, the Apollo and Greek Theaters or Ravinia released.

Within our cultural bureaucracy are certain rules that have prevented capitalization of the live content market up to this time. In the music field alone, the major labels and producers own the exclusive rights to all releases of their featured artists including the grander productions. To protect relationships with retailers and ensure continued revenue streams from popular albums, labels have avoided placing competing releases in the marketplace. Often, if a new concert will contain a performance of previously recorded titles or if a particular artist has not sold well in the marketplace (not uncommon for classical artists), the label will not make the new concert available.

Most importantly, the labels and entertainment companies have believed that the potential market size for live recordings may be lower than the market size for more commercial recordings. Ergo, the costs associated with prior methods to effect the sale have proven prohibitive. This has been particularly disadvantageous for newer, developing artists who are just building a following. Since these acts are for the most part unsigned, in actuality there is no obstacle, other than cost, which would prevent their offering audio or audiovisual copies of their own concerts for sale. Many start-up bands are now considering not signing with a label at all especially since it has become increasingly apparent that the labels are not in optimal control of the market.

On the other hand, it is well known that a significant number of attendees at live entertainment events desire a recording or souvenir of that event which would allow them to re-experience the event. In addition, statistics show that many find that live or “recorded as live” events are more satisfying than highly edited and highly planned “studio” recordings. Fans of an artist usually covet a complete repertoire. Separate from whole concerts or complete ballgames, an artist's or sports celebrity's pin-ups from particular events sell extremely well. Minor league sports teams are now becoming more popular as are arcade tournaments and celebrity-endorsed games, especially those tied to the release of a new film, tour, album or TV series.

The proof can be found in the “warning” message to the audience heard before virtually every live performance, stage presentation or professional sports competition, informing patrons that recording is illegal and strictly forbidden. This demonstrates a clear positive market for the live recordings, even if the quality might be less than optimal or if the to-be-performed titles by that artist are already available for purchase. An exception may only be when an owner or major producer has already decided to sell to broadcast or distribute in a grand scale the exact event attended. In such regard, and in only this instance, would the present invention not serve as useful a purpose, but a useful purpose nonetheless.

To date, many other problems are associated with the marketing of live recordings. The cost of separately producing and marketing; the cost of manually gathering the information associated with the sale; the job of securing the artist's approval prior to release particularly if contract so mandates; the headache and overhead of royalty and music publishing administration including calculating payments to performing rights societies; the actual costs of production including payment of union vs. non-union fees; the possibility of litigation; the technological limitations of disk burning; and the long wait the customer has traditionally had before he or she receives his recording. All these factors have combined to deter exploitation of the live recording market and certainly, making a release available to the public immediately upon the completion of the live event.

Probably the greatest obstacle to live recording distribution, however, remains industry control of talent. Due to powerful contracts even with the most popular artists and talent, owners and producers have traditionally held all the strings to prevent introduction of competing releases.

With the onset of the digital age and the proliferation of peer-to-peer file sharing programs such as “Napster” and encryption decoders, however, digital piracy has crippled the market. Today's news is that all major producers, labels, studios and content suppliers are reevaluating their positions. Copyright holders, producers and team owners have been in a tizzy to reverse the spiraling monetary losses emanating from confiscation of digital product over the Internet. The story this week is that movie houses—not just airlines and concert venues—are scanning patrons for metal recording devices. DVD's in wide-screen format are now readily available on the World Wide Web prior to the national release date of a new film when the primary first-run revenues are realized.

### SUMMARY OF THE INVENTION

The present disclosure presents a clearly novel, useful and unobvious method and system to efficiently and economically capture all otherwise lost live content by coupling ticket sales to purchases of recordings emanating therefrom so that the public can re-experience the event, own event memorabilia or both. It further discloses an integrated method and system to ensure payments to copyright holders by managing and distributing all accounting and payments from the point of sale, and, to electronically and automatically track or otherwise deter digital uploads of copies sold. It provides a novel, long-awaited solution for maximizing revenue from already installed live bases at public venues including, but not limited to, concert halls, outdoor arenas, theatres, ball parks, sport stadiums, theme parks, arcades, hotels, luxury liners, churches and synagogues, etc., by giving the public the opportunity to re-experience these events, which as demonstrated in the present disclosure, are most effectively and at lowest cost, linked to a venue's ticket sales for that particular event.

The present invention is a complete system and a method which provides a legal, efficient way to effect the sale, gather the required information and transmit that information to all parties required for manufacture/fulfillment of the sales and those entitled to share in the purchase, while at the same time, to do so at a cost low enough to make it practical even at low volumes. The present disclosure also presents integrated means and systems for expeditiously producing edited and/or derivative versions of the recording as well as deterring Internet piracy or other confiscation of product.

Equally important, by returning control of creative product to the copyright holders, owners and producers, it will encourage new talent to remain within structure of the existing system, thereby providing a win-win solution to all—talent, studio, labels and participants alike—as well as all involved in offering the public the wonderful experiences of live productions.

The present invention eliminates most if not all inadequacies and disadvantages of the prior art.

“Recording” as used in the present disclosure is defined to mean any audio, video or audiovisual material or data, copyrightable, patentable, edited or otherwise, including VCR tape, disc (CD/DVD), magnetic cassette, reel-to-reel, LP, digital file, or the like emanating from the live event that can ultimately be affixed in tangible form or received by a third-party including but not limited to a purchaser or licensee, and which incorporates the whole or any part of the live event, and/or which can be transformed into “bits” and/or a digital file including, but not limited to, music, video, audiovideo, concert, recital, stage presentation, display, sport competition, arcade tournament, game, theme park amusement, lecture/speech/seminar and photograph/still.

The present disclosure provides integrated methods and systems for electronically transmitting the ticket purchase information to those responsible for fulfillment and accounting of the sales and those entitled to receive payment for the recording by law or contract, while at the same time, serving to deter Internet piracy by providing an integrated but wholly optional method and system for tracking and/or deterring digital uploads throughout the system. This may or may not include distributing recordings that are separately encrypted and/or destructible by known industry means.

Also disclosed are optional, integrated methods and systems for offering edited or other derivative releases, including, but not limited to, so-called “best of” compilations, director's cuts or narration track versions. These are anticipated to be attractive when multiple performances event take place at the same or different venues. Separate, integrated methods and systems are disclosed for linking editing/production technology, as currently exists or may hereafter be devised, to the ticket and purchase orders and/or the system as a whole. Further disclosed are integrated method and system for processing outside orders for the live event recordings from those who did not attend the event.

These methods individually and in total comprise the collection and input of information at the time of sale, the manipulation and secured transmittal of that information to all parties responsible for the fulfillment and manufacture of the recording as well as to those entitled to payment. For those instances where the recordings are to be delivered by immediate and/or electronic transmission directly at the venue after completion of the live event, methods and systems of authentication of the information of ticket holder and/or ancillary purchaser may be incorporated to ensure delivery to the proper party at the time of retrieval.

### BRIEF DESCRIPTION OF THE DRAWINGS

FIG. 1 depicts the Overall System Schematic of all methods and systems contained in the present disclosure.

FIG. 2 depicts the method and system for transaction flow including processing and administration of recording orders, payments and accountings to all copyright holders and participants.

FIG. 3 depicts the methods and systems for Internet processing.

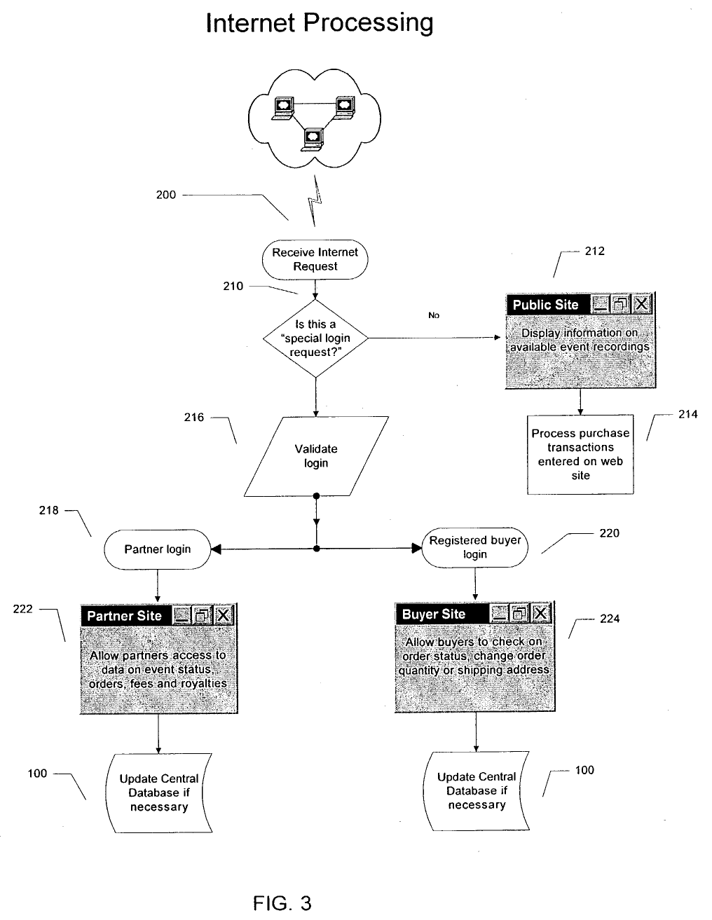

FIG. 4 depicts the method and system of manufacturing/fulfillment including orders for complete recordings and derivative or edited versions.

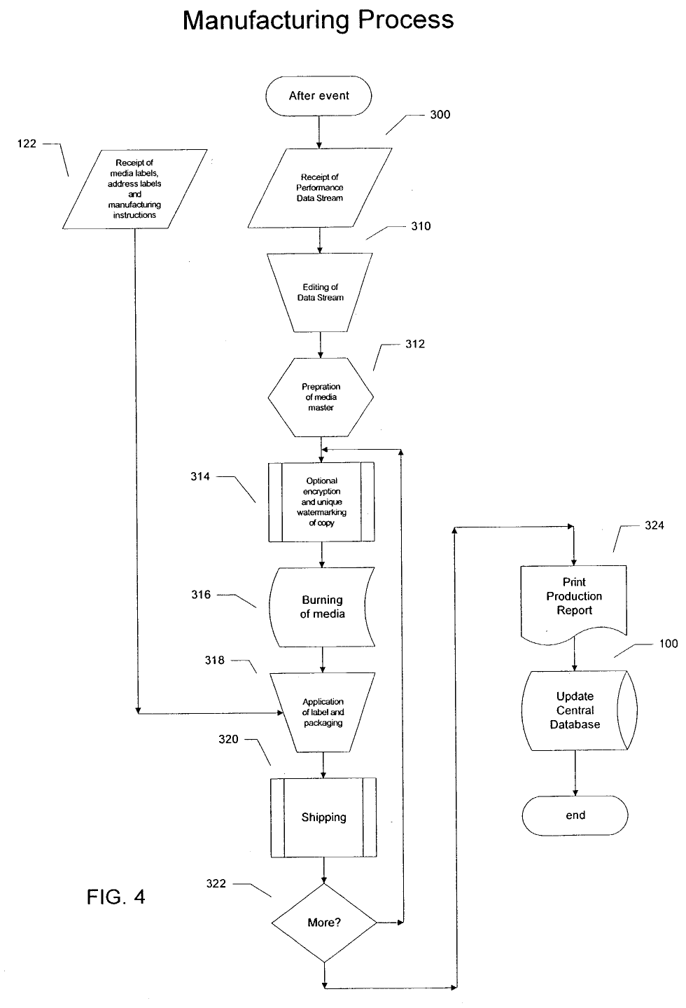

### DETAILED DESCRIPTION OF THE PREFERRED EMBODIMENT

While the instant invention is susceptible of embodiment in many different forms, there is shown in the drawings and will herein be described in detail preferred embodiments of the invention with the understanding that the present disclosure is to be considered an exemplification of the principles of the invention and is not intended to limit the principles or scope of the invention to the embodiment illustrated.

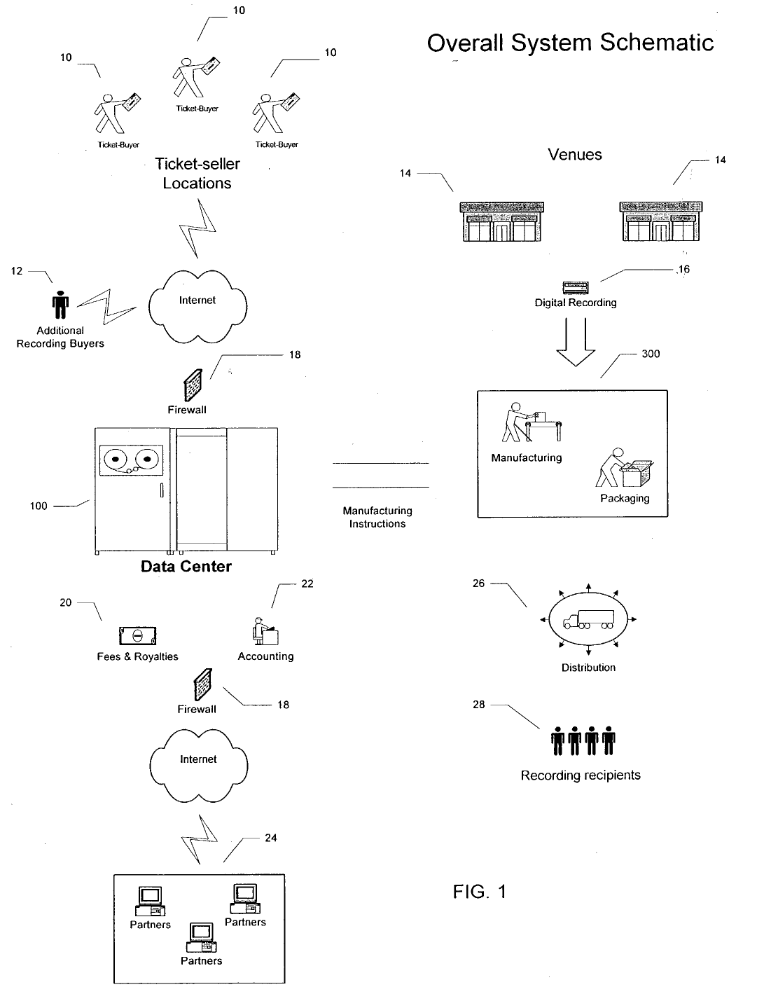

As is now standard in the industry and in referring to FIG. 1, the system architecture of the preferred embodiment of the present invention is implemented using a data center, a plurality of venues using standard point of sale equipment and a plurality of terminals. The data center is in communication with each venue and each terminal through the Internet or any wireless application. The termination can be any device through which a user can access a Website, e.g., a personal computer, a personal digital assistant, an Internet-through-television device, or any type of many available wireless devices available in the market.

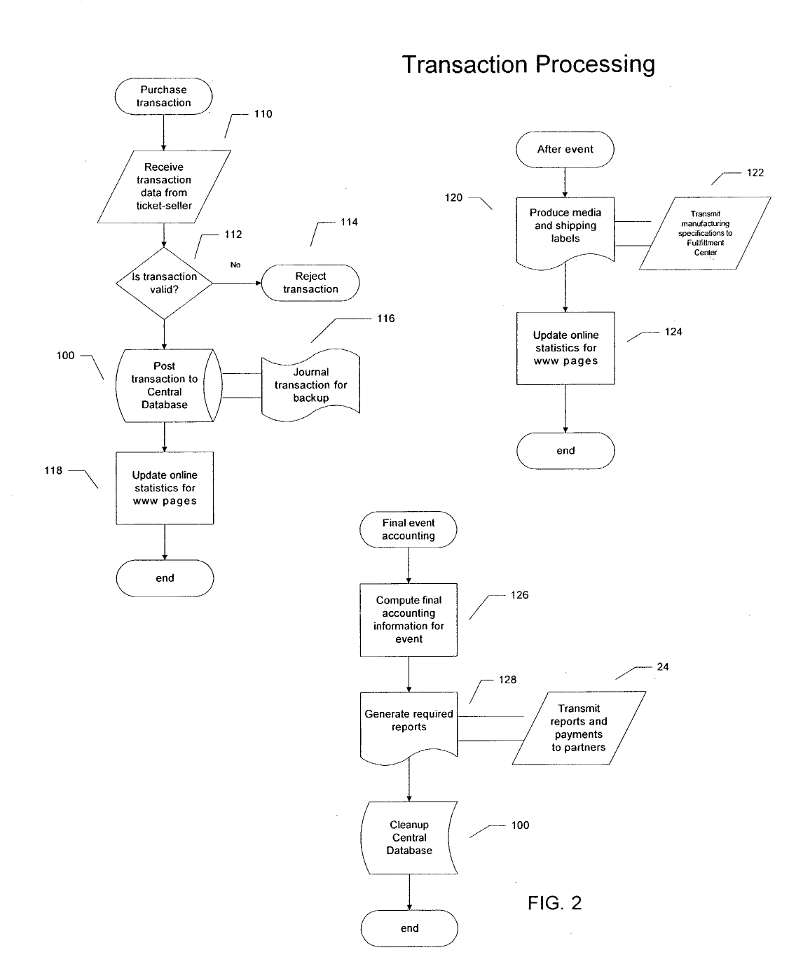

Referring to FIG. 2. the data center (100) preferably comprises database servers, Web servers, a load balancing router and a firewall (18) connected to the Internet. The firewall receives messages from the Internet and forwards the messages to the load balancing router and likewise receives messages from the load balancing router and forwards them to the Internet. The firewall (18) preferably performs a number of filtering functions and network address translation in order to safeguard the data center from unauthorized access. The firewall also preferably encrypts the message using known public key/private key encryption methods. The load balancing router forwards messages received from the firewall and forwards the messages to one of the plurality of Web servers. The loan balancing router also forwards messages received from the Web servers to the firewall. In this manner, the load balancing router distributes tasks to be performed to one of the plurality of Web servers in order to distribute processing demands. The Web servers access the database servers to retrieve and store information in response to received messages from the terminals. The database servers store data tables which contain information about various venues, events, accounting, royalties due, fixed payment allocations, ticket resources, user roles, ticket status, ticket holders.

In order to implement the present invention, an end user can access the data center by using a standard Web browser on the terminal. However, non-standard, custom software can also be implemented or Web browser software on the wireless device such as a personal digital assistant. Terminals can log into the data center to view events which will take place in the future, purchase tickets and/or allow patrons to access arecordings from the just-completed live event (212).

Moreover, user roles may be implemented such as venue, management, artist, record label, team owner, event management, ticket buyer/ancillary purchaser or those who order their recording immediately at venue, or for delivery by home access, or those that order derivative works or elect to input other demographic information for dissemination i.e., best of, director's cut, narration track, requesting download of demographic, etc. (214).

More particularly, referring to FIG. 1, a system in accordance with the present invention includes a data center (100), a plurality of ticket-seller locations (10), a plurality of entertainment venues (14), a fulfillment center (300), a plurality of information fee recipients (24) and a plurality of recording recipients.

The transaction flow is depicted in FIG. 2. The ticket buyer is presented with the option of purchasing the recording at the ticket-seller location. If he agrees, the price of the recording is added to the price of his purchase to the live event. In the event the purchaser desires to retrieve his recording at the venue immediately upon completion of the performance, standard authentication methods may be employed, including, but not limited to, bar coding and/or information authentication.

The ticket-seller, who is already making various allocations for taxes, fees, etc., from the gross receipt, treats the price of the value added recording similarly. He subtracts his fee, whether fixed or contingent (his incentive to provide this service), and forwards the remainder to the recording supplier (recording-seller). Because this is still a single transaction, with the ticket even serving as the customer's receipt, the added cost is minimal.

The ticket seller transmits the transaction data over a PC or other standard point-of-sale equipment well known in the art, which includes the information, gathered from the charge card transaction, which identifies the buyer and specifies the address (the charge card address) to which the recording is to be sent, to the data center (110). This transmission is done in real time, through the Internet, using industry standard protocols such as XML and is properly secured using one of many industry standard encryption methods.

Upon receipt at the data center, the transaction information is immediately loaded into the master system database (100). The database system is capable of recording a multitude of transactions involved a multitude of events simultaneously, while at the same time providing all of the required reporting and processing functions and maintaining both the physical and logical security of the information which is critical to the successful implementation of the method.

The preferred embodiment requires the use of an industry standard database system, e.g., Oracle, Microsoft SQL Server, IBM DB2, etc., which is scalable, and of an industry standard set of server hardware, which is also scalable to ensure that it can handle whatever transaction load is required.

The data center also encompasses a series of Web servers (200) providing as Web sites and/or Web services points of access for various interested parties to retrieve information to which they are entitled.

The ticket/recording buyer can, for example, check on the status of his order (224) and perform a limited range of functions, such as changing the delivery address for his order, or order additional recordings.

The entertainment companies can, for example, check, in real time, to see how many recordings for their artist have been sold for any event (222), and track the royalty and other payments through the system. If the buyer opts to allow dissemination of other demographic information including, for example, his order for promos, tickets for upcoming events or releases, and other merchandise, the system will accommodate those requests. By integrated method and system, it will also accommodate requests for edited versions and/or derivative works including but not limited to “best of” releases, director's cuts or narration tracks as added release options for the live event.

The data center maintains security and confidentiality through the system. The entertainment entities are issued specific password credentials which are authenticated through standard industry techniques (218). In the case of the ticket/recording buyer, his ticket number along with information not printed on the ticket, such as his billing address or other identifying information is used for verification before he can gain access to the privileged areas of the processing Web site.

After sales for a particular event have concluded, the data center sends to the fulfillment house (122) information specifying the number of recordings (120) to produce and the addresses to which they should be mailed.

If attendees want to take home their live recording directly at the venue upon completion of the event, standard authentication methods, including but not limited to bar coding, may be incorporated. In one example embodiment, the recordings are “burned” on site. The attendee would insert his ticket into an automated “vending machine” which would dispense the recording to which he is entitled. In another, he would insert his ticket into a burning/vending machine to begin the burning process.

The data center also handles all tasks of reporting and accounting for all participants and generates detailed statements and accounts including the amounts of statutory and contractual royalties (20).

The fulfillment center handles the actual production of the recordings and affects their delivery to the ticket/recording buyer.

To summarize, a recording of a live event (including any edited and/or derivative forms thereof) is ordered by a buyer who has attended the event or by a non-attendant buyer by any available means including, but not limited to, by using an appropriate Website.

While the specific embodiments have been illustrated and described, numerous modifications come to mind without significantly departing from the spirit of the invention and the scope of protection is only limited by the scope of the accompanying claims.

I claim:

1. A system of electronically associating the sale of a recording emanating from a live entertainment, sports or other live event with the sale of a ticket for that event, the system comprising:
a. means for associating the sale of the recording with the sale of the ticket for the event;
b. means for acquiring from ticket sellers information defining and authenticating the purchase of the recording and/or its type and/or its desired method of delivery;
c. means for integrating approvals required of those parties having the right to approve the recording prior to its distribution;
d. means for integrating orders for derivative or edited versions of the recording from ticket and ancillary purchasers;
e. means for integrating the accounting and fee distribution services required;
f. means for transmitting to the fulfillment center the information needed to generate and deliver the recordings;
g. means for transmitting to the manufacturer the information needed to generate and deliver the recordings;
h. means for transmitting and integrating all costs, expenses and payments regarding production and manufacture of the recording;
i. means for generating and transmitting all reports and accountings to all interested parties as may be coupled with secured technology to ensure confidentiality of certain information; and
j. means for creating, generating and facilitating the Web sites and Web services required to provide in real-time, on-line, secured access to information used in the operating of the system and its related facilities.

2. The system of claim 1 wherein the means for associating the sale of a ticket to the event with the sale of a recording emanating from the live event comprises a computer software program operated as part of a ticket-seller's or issuer's system.

3. The system of claim 1 wherein the means of acquiring the information from the ticket sellers comprises a computer software program operated as part of the ticket-sellers system and another computer software program operated as part of the recording seller's data center.

4. The system of claim 1 wherein the means of performing the various data processing functions required of the recording-seller's data center comprise a series of computer software programs operated as part of the recording seller's data center.

5. The system of claim 1 wherein the means of retrieval of the recording is by automated, expedited delivery and retrieval by the ticket buyer/attendee or other purchaser at the venue by the time the live event is over, with integrated optional methods of authenticating order with the retriever.

6. The system of claim 1 wherein the editing technology used for the production and release of the recording and edited and/or derivative releases is linked to the ticketing information and/or other components of the systems herein disclosed.

7. The system of claim 1 wherein recording orders from purchasers who did not attend the event are integrated with the systems herein disclosed.
